(19) United States
(12) Patent Application Publication
(10) Pub. No.: US 2010/0175047 A1
(43) Pub. Date: Jul. 8, 2010

(54) ASSOCIATING ADVERTISEMENTS AND GAME DATA IN A FLASH-BASED GAMING ENVIRONMENT

(76) Inventors: David Simons, Toronto (CA); Kelly Slough, Northampton, MA (US); Steven Woods, Los Altos Hills, CA (US)

Correspondence Address: FOLEY & LARDNER LLP, 150 EAST GILMAN STREET, P.O. BOX 1497, MADISON, WI, 53701-1497, US

(21) Appl. No.: 12/349,050

(22) Filed: Jan. 6, 2009

(51) Int. Cl. G06F 9/44; G06F 3/048

(52) U.S. Cl. 717/113

(57) ABSTRACT

A method of associating advertisements with a computer software product includes loading an executable software file containing software code that upon execution carries out a software program, parsing instructions in the loaded executable software file, presenting the parsed instructions in a user interface, receiving transformation instructions to be applied to the executable software file, and applying the transformation instructions to the executable software file to produce a transformed executable software file. The transformation instructions include location information for displaying an advertisement before, during, or after execution of the software program.

### FIELD

The subject of the disclosure relates generally to advertising within a gaming environment. More specifically, the disclosure relates to associating advertisements and game data in a FLASH-based gaming environment.

### SUMMARY

The Adobe Flash player is a widely available graphical run-time computing environment. It runs on devices ranging from cellular phones to personal computers and is compatible with most operating systems commonly found on such devices. Although originally developed as an environment for producing computer animation sequences and movies, this ubiquitous support has also made it a popular choice as a programming and run-time environment for delivering online video games to consumers.

The executable game format delivered from game developers to game publishers and distributors is Adobe's proprietary Flash SWF (Shockwave Flash) file format. This file consists of binary bytecode instructions and data that is interpreted at runtime by the Flash player application to render the interactive game.

Game publishers and distributors seek to monetize games with a variety of business models including advertising-driven revenue. They may also wish to create a social environment around online Flash games that allows players to compete head to head, compare scores, issue challenges and track their competitor's progress. Flash games as built by the developer and delivered to the publisher do not typically allow a publisher to build advertising into the game or determine the player's current score and progress through a game as it is played.

A representative implementation includes a toolset and process by which games delivered in the Adobe SWF executable file format can be enhanced, without access to any of the source code files, graphics, fonts or data. While the types of enhancements that can be made with this toolset are virtually unlimited, the current process applies most directly to enhancements related to adding in-game advertising as well as extracting score and progress information from an actively running game. The types of advertising that can be enabled with this toolset and process include but are not limited to pre-roll, interstitial and post-roll video ads that occur during natural breaking points in game play, overlay ads that appear during game play without being overly intrusive on the game play experience and product placement advertisements in which branded imagery is added in context to the game play scene. It should be noted that while the present disclosure describes several representative embodiments in terms of using Adobe Flash software, this description should not be interpreted to limit embodiments to use of only the Adobe Flash software product.

In a first representative embodiment, a method of associating advertisements with a computer software product includes loading an executable software file containing software code that upon execution carries out a software program, parsing instructions in the loaded executable software file, presenting the parsed instructions in a user interface, receiving transformation instructions to be applied to the executable software file, and applying the transformation instructions to the executable software file to produce a transformed executable software file. The transformation instructions include location information for displaying an advertisement before, during, or after execution of the software program.

In a second representative embodiment, a system for associating advertisements with a computer software product includes a file parser, a viewer, an enablement file, and a processor. The file parser is configured to parse instructions in a loaded executable software file. The viewer is configured to present the parsed instructions in a user interface and provide an interface for user input. The enablement file includes pre-defined blocks of computer code for handling initialization of data structures, playing a pre-roll advertisement, playing an interstitial advertisement, and extracting game player achievement information. The processor is configured to execute programmed instructions to receive transformation instructions to be applied to the executable software file. The transformation instructions include location information for displaying an advertisement before, during, or after execution of the software program and apply the transformation instructions to the executable software file to produce a transformed executable software file.

In a third representative embodiment, a method of associating advertisements with a computer game product includes parsing instructions in an executable game software file associated with a software game program, presenting the parsed instructions in a user interface where the user interface includes a first portion configured to display the software game program during execution and a second portion configured to display the parsed instructions, receiving transformation instructions in a third portion of the user interface where the transformation instructions include location information for displaying an advertisement along with the software game program, and applying the transformation instructions to the executable software game file to produce a transformed executable game software file.

Other principal features and advantages will become apparent to those skilled in the art upon review of the following drawings, the detailed description, and the appended claims.

### BRIEF DESCRIPTION OF THE DRAWINGS

Representative embodiments will hereafter be described with reference to the accompanying drawings.

FIG. 1 is a flow diagram illustrating operations performed by an advertising delivery system in accordance with a representative embodiment.

FIG. 2 is a block diagram illustrating an advertisement delivery toolset in accordance with a representative embodiment.

FIG. 3 is a graphical user interface (GUI) for controlling the advertisement delivery toolset of FIG. 2 in accordance with a representative embodiment.

FIG. 4 is the GUI of FIG. 3 having frame information shown in a section of the GUI in accordance with a representative embodiment.

FIGS. 5 and 6 are closer views of the GUI of FIG. 4.

FIG. 7 is a general block diagram showing a beaconing service in accordance with a representative embodiment.

### DETAILED DESCRIPTION

The Adobe Flash system includes a visual development environment that saves and works with Flash programs in their “source code” format, which is a proprietary binary-formatted FLA file. When a Flash movie or game is distributed to end users, the Flash development environment “publishes” the content into an executable form. This executable form of Flash content is a proprietary binary-formatted SWF file containing bytecode instructions and data that completely specify the execution of the content. The Flash player is the run-time environment that is responsible for interpreting and executing the bytecode and data in the SWF file.

SWF files contain a series of tags that describe the visual elements and sounds used in the game, along with their movements and transformations. In addition to these tags, the developer of the game can include logic written in the ActionScript scripting language. During the publishing process, this ActionScript logic is transformed from its textual representation to a bytecode representation in the SWF file. While not a completely reversible process, it is possible however to re-interpret this bytecode representation such that the original ActionScript that produced it is approximated sufficiently to allow its understanding and modification by a skilled practitioner.

To demonstrate the operation of a representative embodiment, a set of commercially available online SWF game files from well known game development studios were used. These SWF game files were obtained either directly from the game development studio itself or from a publisher of the game. In all cases, the games were the standard issue as would be given to any and all publishers of the game.

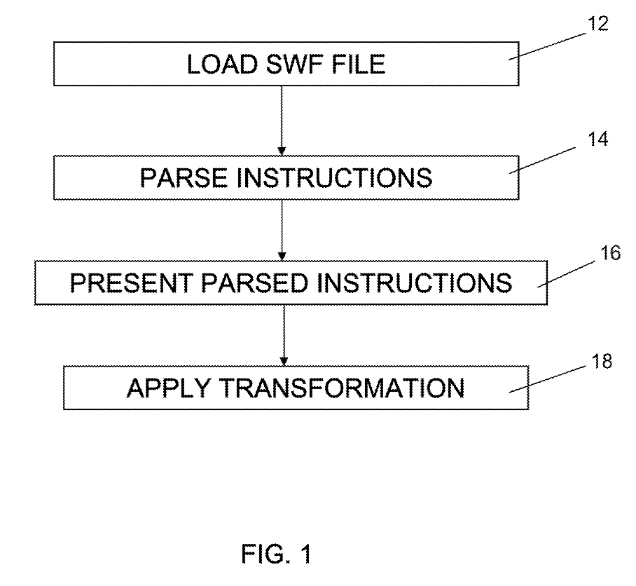

FIG. 1 is a flow diagram illustrating operations performed by an advertising delivery system in accordance with a representative embodiment. Additional, fewer, or different operations may be performed in alternative embodiments. In an operation 12, a toolset loads a SWF game file and in an operation 14 parses the instructions contained therein based on publicly available documentation of the SWF file format. A visual representation of the parsed SWF file is then prepared and presented to the user of the toolset in an operation 16. This visual representation of the SWF file allows the engineer in charge of enhancing the game to see the internal structure of the SWF file and identify the areas of the SWF file that contain instructions related to the enhancements being made to the game. The engineer can take advantage of features of the toolset to automatically search, filter and identify the relevant sections of the parsed SWF file.

Once the engineer has determined the changes that are necessary, the engineer prepares a short document that describes the transformation to be applied to the game SWF file. This transformation specification document can include specifying points at which to insert, merge and/or replace instructions in the game SWF file with instructions from a second SWF that is part of the toolset (the toolset SWF) and contains standardized logic related to advertisement selection and display, and extraction and communication of game score and progress information. Further, the transformation document can include specifying one or more instructions that are to be removed from the game SWF. Yet still further, the transformation document can include specifying insertion, modification or replacement of elements of the game SWF file based on information specified completely within the transformation specification document itself.

In an operation 18, a transformation operation is performed in which the transformation specification document is applied to the game SWF, producing a new enhanced game SWF. Because this transformation operation is completely specified by the contents of the transformation specification document that was prepared by the engineer, it can be applied at any time during the process of preparing the enhanced game for release, and does not require the specialized skills of the engineer. It allows the option to separate the task of enhancing a SWF game into two roles: a specialized engineer who prepares the transformation document, and a person who applies the transformation. It also allows the transformation to be quickly and easily re-applied to the game SWF if and when the contents of the toolset SWF are updated.

According to a representative embodiment, when the transformation is applied, only those elements of the game SWF that have transformations specified are modified in any way. The remainder of the elements of the SWF file are not modified in any way. When the enhanced game SWF file is produced, those non-transformed elements of the SWF file are written to the enhanced game SWF file with exactly the same byte sequence as in the original game SWF file. Thus, any elements of the SWF file that are not involved in the transformation are guaranteed immutable and not subject to faulty interpretation and modification in the enhanced game SWF.

The following further describes the tools and process used to transform a SWF-based game into a new SWF file that contains additional logic to display video ads at appropriate points during game play as well triggering events containing player achievement information that can be used by the hosting container (eg. a website) to enable community based features.

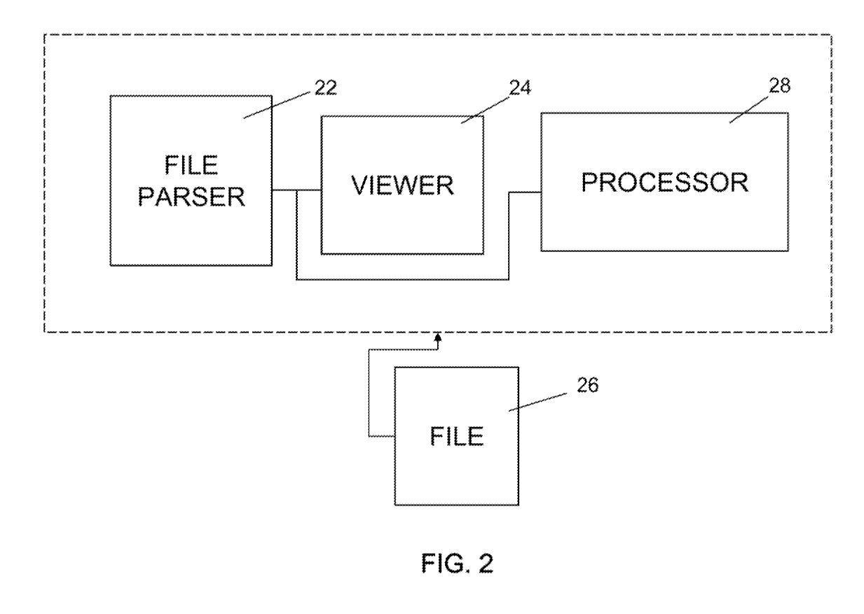

FIG. 2 illustrates components in a representative toolset 20. The toolset 20 includes a GUI-based SWF file parser 22, viewer 24, and an “Ad Enablement SWF” file 26 that is a compiled Flash SWF file that contains logic related to each aspect of the SWF game file for modification. The “Ad Enablement SWF” file 26 contains pre-defined blocks of logic that handle initialization of data structures, play a preroll ad, play an interstitial ad, and extract and expose player achievement information. The job of the ad technician in this process is to specify the positions within the game SWF file to weave in the necessary logic from the Ad Enablement SWF file 26. The toolset 20 includes a processor 28 which is programmed to analyze the bytecode instructions contained in the Flash SWF file for the game. The processor 28 also performs operations to implement the transformation specification associated with a game SWF file and create a transformed game SWF file.

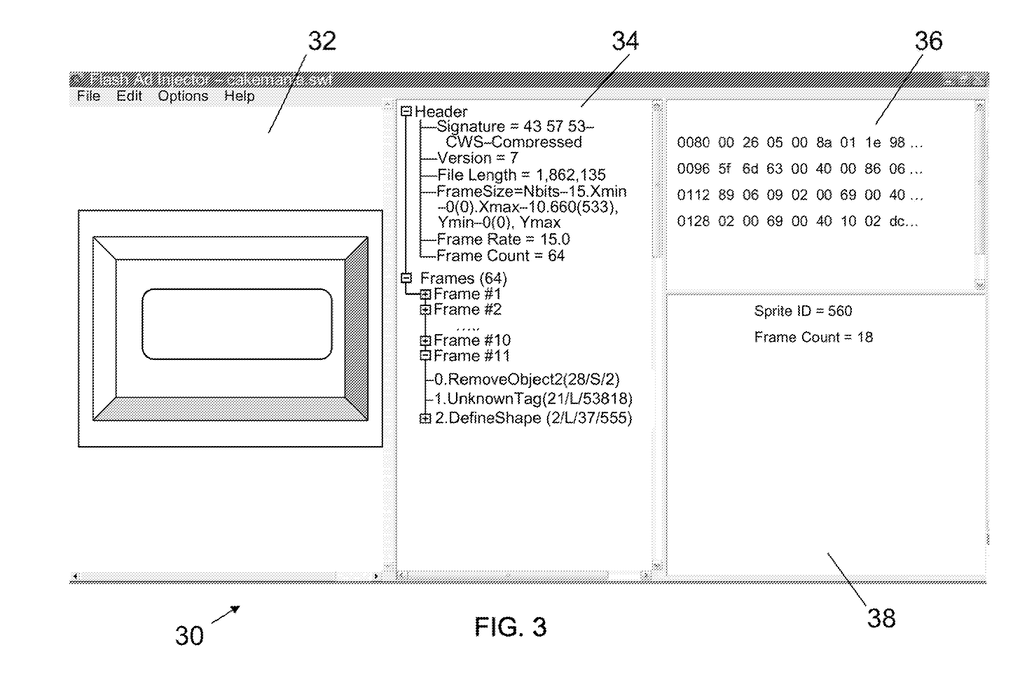

FIG. 3 illustrates a representative GUI (graphical user interface) 30. The GUI 30 includes sections 32, 34, 36, and 40. Section 32 includes a panel showing the game running in an instance of the Flash player. Section 34 provides a visual representation of the properties in the header of the Flash movie at the top and below a hierarchical representation of all the bytecode contained in the file. The bytecode is divided into a series of frames, each containing a hierarchical set of tags. Section 36 includes raw hexadecimal representation of the bytecode contained in a tag that has been selected in the hierarchical view. Section 38 displays more details about the properties of the tag selected in the hierarchical view.

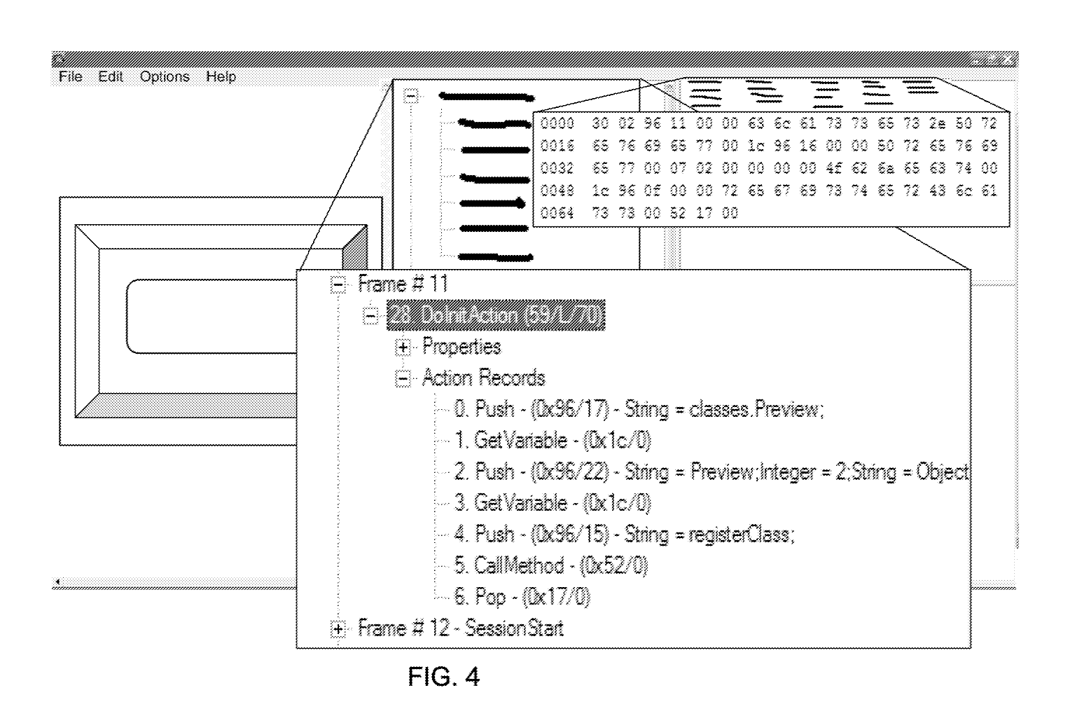

In a typical Flash SWF game, there are thousands of individual tags in the file, with each tag possibly having a deep complex hierarchy of child tags. It is advantageous to have a fast way to identify the sections of the tag hierarchy that are modified to achieve the desired goals, whether those are to insert interstitial ads, overlay ads or to expose achievement information such as score to a website. A filtered view of the tags can be created so that only tags of interest are displayed, such as in the screenshot of FIG. 4, where only tags containing ActionScript instructions are displayed.

Additional methods of narrowing the search are also available. The Flash game in section 32 is interactive and can be played. While it is being played, the Frame number that is active is highlighted in section 34. The technician can play the game to determine the active frame at the time when an ad is to be shown or the score extracted and focus their subsequent efforts at modifying the actions contained in that frame. It is also possible to search for specific text strings in the ActionScript in the Flash file. It is also possible to decompile the ActionScript in the Flash file and display it in a view similar to the original source code, rather than in the hierarchical tag-based format shown in the GUI 30.

Using these methods of narrowing the search and understanding the bytecode in the SWF file, the technician selects specific tags within the SWF file that need to be modified. Modifications to the SWF file can include playing a pre-roll advertisement (e.g., a video ad displayed during the initialization sequence for the game), playing an interstitial advertisement (e.g., a recurring video advertisement displayed during a natural breaking point in the game, such as between levels), and at the end of each level, determining the user's score and generating an event that is passed out from the Flash game to its website. To play a pre-roll advertisement, the technician identifies a point where the Flash game playback can be paused while a video advertisement is shown.

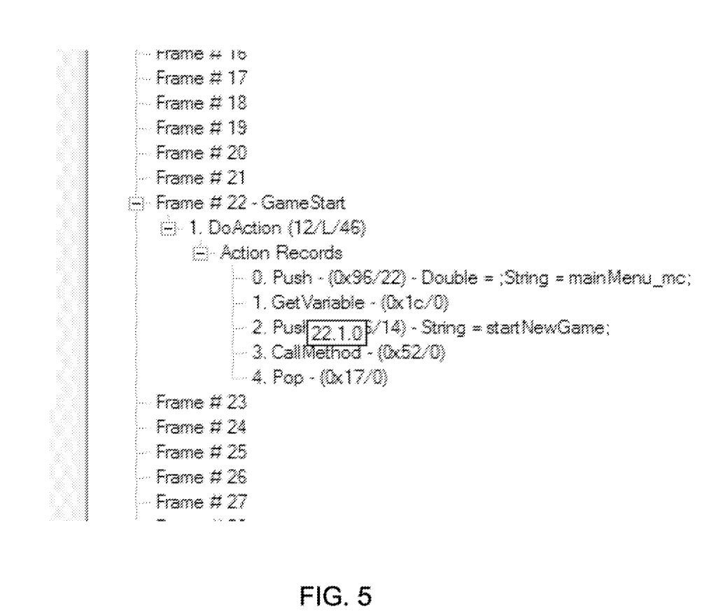

FIG. 5 shows a series of ActionRecords contained within Frame 22 of the game that invoke the ‘startNewGame’ function. An appropriate place to show a preroll ad is immediately before invoking this function. Therefore, the ad technician can select this as the point to insert the pre-defined block of logic from the Ad Enablement SWF that plays a preroll advertisement. The above set of ActionRecords are modified such that logic to play a preroll ad is inserted ahead of this function call. When the preroll ad is done, the ad playing logic invokes the ‘startNewGame’ function.

Similarly, the ad technician identifies a recurring point in game play that occurs at a natural breaking point, such as between levels of a game. The technician then identifies a block of logic within the game SWF file that is executed at each of these break points, and selects a series of ActionRecords ahead of which the logic for displaying an interstitial ad is inserted. This interstitial ad display logic block continues on to the specified ActionRecords after the ad has been displayed.

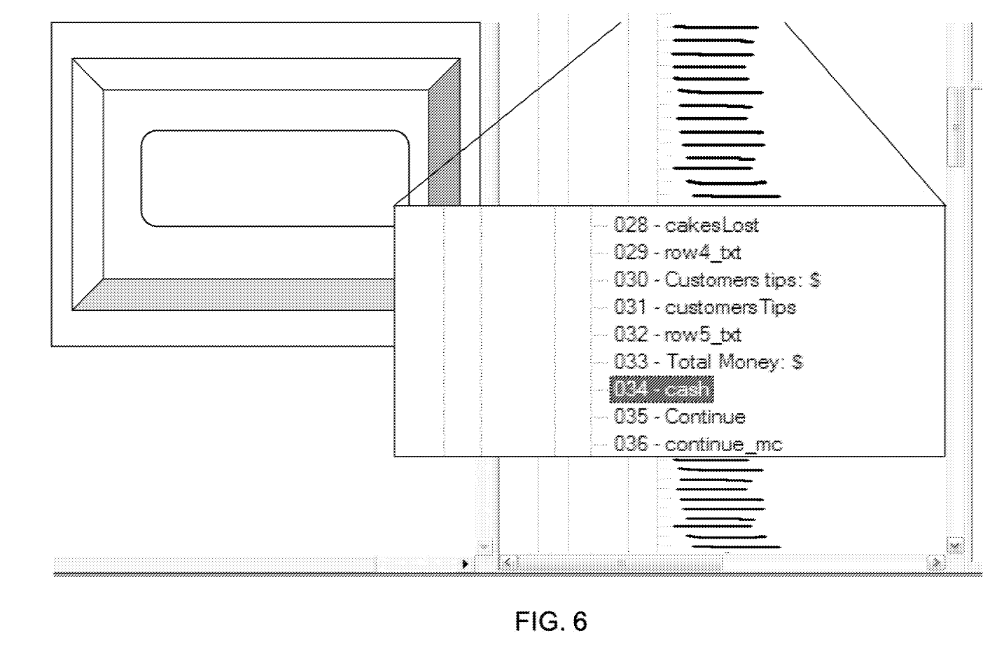

For extracting and exposing player achievement information, the ad technician identifies the variable(s) within the SWF game logic that store the player's score, current level, and other items of interest. Once these variables are identified, as in FIG. 6, the toolset inserts logic into the game SWF to trigger an event that passes the value of this variable out to the container that is hosting the game SWF. In most cases, this event is exposed to the javascript in the web page that is hosting the Flash player object.

At the end of the process described above, the ad technician and toolset has produced a transformation configuration file that contains a specification of how the game SWF file is transformed into the ad-enabled, community feature enabled version of the game. A sample of such a configuration file, generated by the toolset, is shown below:
Line 1: \Services\AdEnablement\FlashOnline\skeleton.swf
Line 2: 3
Line 3: Preroll:22.1.0-22.1.4
Line 4: lnterstitial:1.96.44.0-1.99.51.2
Line 5: Score:1.99.51.2-1.99.51.2
Line 6: $Score=Register:2.Constant8.21.Constant8:34

The first line defines the location of the Ad Enablement SWF. The second line defines the frame number in which to insert the initialization code. The third line defines the position in the file where the preroll ad logic should be merged. The fourth line defines the position in the file where the interstitial ad logic should be merged. The final two lines define the variable containing the player's score and the location in the game SWF in which logic should be added to trigger the event exposing the score data.

Transformation of the SWF file draws to an end when the toolset applies the transformation configuration file to the game. The output of this stage is a modified game SWF in which the user experience of the game remains identical to the original with the exception of the addition of video advertisements at specific points during game play. This modified game SWF is saved and can be packaged and distributed in the same manner as the original game. Because the advertisement display logic is built right into the SWF game itself, even if unauthorized websites obtain and host this modified game, they will also display ads and the ad revenue will flow to the company that originally hosted the modified game SWF. This scenario is in contrast to the traditional model of generating advertising revenue for hosted Flash games in which the SWF game file itself contains no advertisement display logic. In this case, ads are displayed by the HTML page that surrounds the Flash player object that is executing the game. In this case, any unauthorized capture and hosting of the game SWF file will enable an unauthorized website to host the game without any advertising revenue going to the company that originally hosted the game SWF.

In another representative embodiment, a pre-roll advertisement is added automatically without involvement of an ad technician. Automatic addition of a pre-roll advertisement includes the addition of preroll ad delivery bytecode logic at the beginning of a computer program, such as a game, prior to any of the game bytecode being executed. In some cases, adding a bytecode requires the creation of a new frame on the main Flash timeline. In other cases, such an addition requires reordering of existing frames on the timeline and/or scanning all the bytecode within the file to adjust any references within the bytecode to absolute frame numbers, which are changed as a result of the addition of a new frame for the preroll ad at the beginning of the SWF.

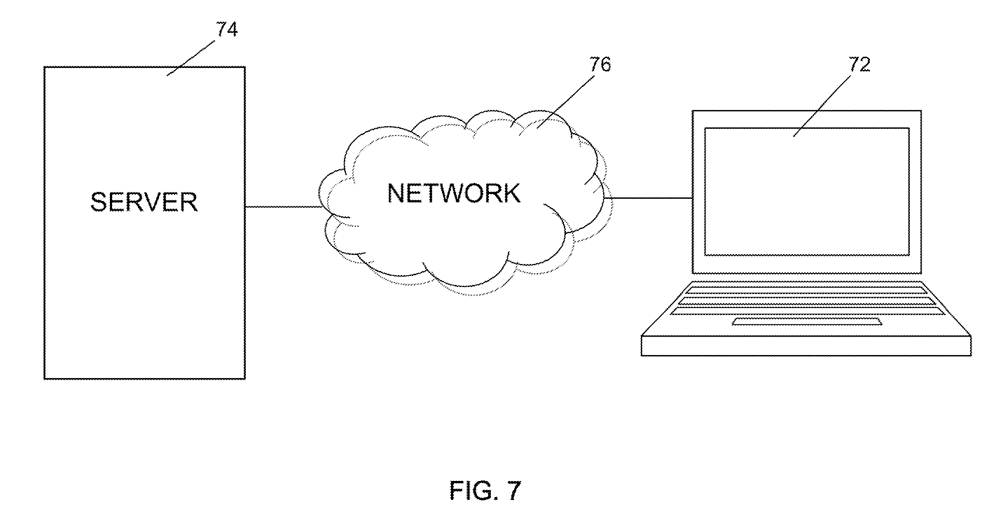

In yet another representative embodiment, a beaconing service is included with the Flash game that does not require a technician to examine the game and define the transformation operation. FIG. 7 illustrates a beaconing operation in which a message is sent from a computer 72 on which the game is played to a server 74 via a network 76. The message provides information regarding the game session durations while the game is being played. As such, the server 74 can receive information on the length of each game play session. Without such messaging, an operator of a Flash gaming website cannot determine how long each game play session lasts because after the game SWF is loaded onto the webpage and starts executing, it typically no longer makes any contact with the server. Without the beacon messages, the website operator does not know at what point the user closes the browser window or navigates away from the page hosting the game SWF to another page. With the beaconing messages added to the game, the website operator knows, subject to the frequency of the messages, how long the user's game session lasts.

The foregoing description has been presented for purposes of illustration and of description. It is not intended to be exhaustive or limiting with respect to the precise form disclosed, and modifications and variations are possible in light of the above teachings or may be acquired from practice of the disclosed embodiments.

What is claimed is:

1. A method of associating advertisements with a computer software product, the method comprising:
loading an executable software file containing software code that upon execution carries out a software program;
parsing instructions in the loaded executable software file;
presenting the parsed instructions in a user interface;
receiving transformation instructions to be applied to the executable software file, wherein the transformation instructions include location information for displaying an advertisement before, during, or after execution of the software program; and
applying the transformation instructions to the executable software file to produce a transformed executable software file.

2. The method of claim 1, wherein the software program includes a software game.

3. The method of claim 2, further comprising presenting a player interface in the user interface, wherein the player interface presents the software game.

4. The method of claim 3, further comprising presenting a visual representation of header properties of the software program and a hierarchical representation of bytecode contained in the executable software file.

5. The method of claim 4, wherein the bytecode is divided into a series of frames, each containing a hierarchical set of tags.

6. The method of claim 4, wherein the software program is a Flash program including a game.

7. The method of claim 4, further comprising presenting in the user interface a hexadecimal representation of the bytecode.

8. The method of claim 1, wherein the user interface is configured to present output of the software program during execution and receive input associated with points in time during runtime of the software program.

9. A system for associating advertisements with a computer software product, the system comprising:
a file parser configured to parse instructions in a loaded executable software file;
a viewer configured to present the parsed instructions in a user interface and provide an interface for user input;
an enablement file including pre-defined blocks of computer code for handling initialization of data structures, playing a pre-roll advertisement, playing an interstitial advertisement, and extracting game player achievement information; and
a processor configured to execute programmed instructions to receive transformation instructions to be applied to the executable software file, wherein the transformation instructions include location information for displaying an advertisement before, during, or after execution of the software program and apply the transformation instructions to the executable software file to produce a transformed executable software file.

10. The system of claim 9, wherein the enablement file is a Shockwave Flash file.

11. The system of claim 9, wherein the user interface includes a software program player that presents the software program.

12. The system of claim 11, wherein the user interface includes an input section for receiving the transformation instructions.

13. The system of claim 12, wherein the user interface includes a display section of header properties of the software program and a hierarchical representation of bytecode contained in the executable software file.

14. The system of claim 13, wherein the software program includes a game.

15. The method of claim 14, wherein the advertisement is removed subsequent to the second time.

16. A method of associating advertisements with a computer game product, the method comprising:
parsing instructions in an executable game software file associated with a software game program;
presenting the parsed instructions in a user interface, wherein the user interface includes a first portion configured to display the software game program during execution and a second portion configured to display the parsed instructions;
receiving transformation instructions in a third portion of the user interface, wherein the wherein the transformation instructions include location information for displaying an advertisement along with the software game program; and
applying the transformation instructions to the executable software game file to produce a transformed executable game software file.

17. The method of claim 16, wherein the parsed instructions are displayed using a visual representation of header properties of the software game program and a hierarchical representation of bytecode contained in the executable software game file.

18. The method of claim 17, wherein the bytecode is divided into a series of frames, each containing a hierarchical set of tags.

19. The method of claim 16, wherein the location information indicates whether the advertisement is displayed before, during, or after execution of the software game program.
